(19) United States
(12) Patent Application Publication
(10) Pub. No.: US 2012/0128852 A1
(43) Pub. Date: May 24, 2012

(54) Use Of Erythritol, D-Tagatose And A Bulking Agent In Low Calorie Frozen Beverages

(75) Inventors: Ijeoma Okpala, White Plains, NY (US); Michael Gonley, Danbury, CT (US); Dave Beneway, Danbury, CT (US)

(73) Assignee: PepsiCo, Inc., Purchase, NY (US)

(21) Appl. No.: 13/289,069

(22) Filed: Nov. 4, 2011

Related U.S. Application Data
(60) Provisional application No. 61/410,459, filed on Nov. 5, 2010.

(51) Int. Cl. A23L 2/60; A23L 1/236; A23L 1/307

(52) U.S. Cl. 426/548

(57) ABSTRACT

A reduced calorie frozen beverage comprising: (a) at least one non-nutritive sweetener, (b) erythritol, (c) D-tagatose, (d) maltodextrin, and (e) a nutritive sweetener.

This application claims priority to U.S. provisional application Ser. No. 61/410,459 filed Nov. 5, 2010, hereby incorporated by reference in its entirety.

### FIELD OF THE INVENTION

The invention relates to reduced calorie frozen beverages and syrup for use in a low calorie frozen beverage, in particular the invention relates to frozen beverages and syrups containing maltodextrin as a bulking agent.

### BACKGROUND OF THE INVENTION

Diet (zero- or low-calorie) beverages or reduced-calorie beverages are very popular. Such products typically contain, singularly or in blends, natural and artificial non-nutritive sweeteners such as Rebaudiside A, Lo Han Guo, aspartame, acesulfame-K, saccharin, sucralose and cyclamate. While consumers do not have to worry about calories, non-nutritive sweeteners are known to impart a taste different from that of full-calorie counterparts. So-called “diet taste” is commonly described as slow onset but lingering sweetness accompanied with a bitter and/or metallic undesirable aftertaste and a watery mouthfeel. Due to the greatly reduced sugar solid content, reduced-calorie drinks also lack the body and/or thickness perception associated with full-calorie drinks.

Reduced-calorie beverages with tastes similar to those of full-calorie products are very desirable and have been sought after for quite some time. One option is to use non-nutritive sweeteners. Another option is to use flavor enhancing ingredients. For example, erythritol is added to beverages for purposes of adding sweetness and bulk which in turn provide flavor enhancement. Additionally, D-tagatose is known to produce improved flavor and mouthfeel at low doses in combinations with high intensity sweeteners.

Despite the success of combining erythritol, D-tagatose, and nutritive or non-nutritive sweeteners in a variety of beverages, there is still a need to improve the mouthfeel and texture characteristics of diet beverages, in particular low calorie frozen beverages.

### BRIEF SUMMARY OF THE INVENTION

One aspect of the invention is directed to a diet frozen beverage comprising: (a) at least one non-nutritive sweetener, (b) erythritol, (c) D-tagatose, (d) maltodextrin as a bulking agent, and (e) at least one nutritive sweetener.

Another aspect of the invention is directed to a syrup for a diet frozen beverage comprising: (a) at least one non-nutritive sweetener, (b) erythritol, (c) D-tagatose, (d) maltodextrin as a bulking agent, and (e) at least one nutritive sweetener.

Further aspects of the invention include addition of a non-nutritive sweetener to the frozen beverage or syrup.

### DETAILED DESCRIPTION OF THE INVENTION

A minimum amount of sugar is required to give frozen products their optimal freeze and also to meet consumer's organoleptic expectations. The level of sugar—solids in particular—affects more than flavor, it also affects the freezing point. When sugar is removed, it is difficult to obtain a mixture having an optimal freezing point to produce a suitable frozen beverage.

Controlling finished product texture is crucial for a pleasant, appropriate mouthfeel. Sweetness and freezing point depression are two key properties required to achieve an optimal product in reduced calorie frozen beverages. Freezing point depression has a direct effect on the overall texture and bulking qualities in frozen products. A successful reduced calorie frozen beverage has excellent texture and taste.

Thus, frozen beverages require bulk solutes from sugar to stabilize small ice crystals for a good taste and a smooth texture. The removal of sugar to achieve a lower calorie delivery results in a product that is not only unable to freeze appropriately, but also doesn't deliver the mouthfeel and texture that is desirable. High intensity sweeteners alone will replace sweetness but will not provide bulk to the product.

The present invention is directed to achieving both sugar-like sweetness and optimal texture by using a combination of high-intensity non-nutritive sweeteners (natural and artificial), bulk sugar replacers (erythritol and D-tagatose), bulking agent (maltodextrin), nutritive sweeteners, and optionally gums.

The inclusion of the bulking agent in low calorie syrups provides additional solids that will help lower the freezing point of the syrup as well as provide “bulk” in order to give the product a more desirable texture and mouthfeel.

In addition, gums used in conjunction with the bulking agent will increase the solids content and control the freezing point. They help not only to maintain finished product characteristics but can also provide stability during temperature fluctuations.

As used herein, “taste” refers to a combination of sweetness perception, temporal effects of sweetness perception, i.e., on-set and duration, off-tastes, e.g., bitterness and metallic taste, residual perception (aftertaste) and tactile perception, e.g., body and thickness.

As used herein, “zero-calorie” means having less than 5 calories per serving, e.g., per 8 oz. for beverages. As used herein, “low-calorie” means having less than or equal to 40 calories per serving, e.g., per 8 oz. for beverages and includes zero calorie. As used herein, “diet” refers to either “zero-calorie” or “low-calorie.” “Reduced calorie” means having a reduced number of calories as compared with a full-calorie counterpart; more particularly, “reduced calorie” as used herein means having less than 80 calories per serving, e.g., per 8 oz. for beverages, typically 10 to 60 calories.

In addition, in order to be designated a “light” or “lite”, product must meet qualifications under the Reference Amount Customarily Consumed (RACC). If 50% or more of the calories come from fat, fat must be reduced by at least 50% per RACC. If less than 50% of the calories come from fat, fat must be at least 50% or calories reduced by one third per RACC.

The present invention is directed to the combination of a non-nutritive sweetener or non-nutritive sweetener blend, erythritol, D-tagatose, maltodextrin as a bulking agent, nutritive sweetener and optionally a gum such as cellulose gum. Overall sweetness, aftertaste duration, mouthfeel and sucrose-like quality of low-calorie frozen beverages are advantageously improved.

According to a first aspect of the present invention, the taste of a low-calorie frozen beverage is improved by including in the frozen beverage (a) at least one non-nutritive sweetener, (b) erythritol, (c) D-tagatose, (d) maltodextrin as a bulking agent, (e) nutritive sweetener, and optionally (f) a gum such as, but not limited to, cellulose gum or xanthan gum.

Beverages include, without limitation, carbonated and non-carbonated frozen ready-to-drink beverages, as well as liquid concentrates or syrups to produce the frozen beverages. Such types of beverages are referred to as frozen uncarbonated beverage (FUB) and a frozen carbonated beverage (FCB).

Non-nutritive sweeteners suitable for use in embodiments provided herein include natural, synthetic, and other high-potency sweeteners. Any natural or artificial non-nutritive sweetener can be employed for present purposes. As used herein, a “non-nutritive” sweetener is one which does not provide significant caloric content in typical usage amounts, i.e., less than about 1 calorie per serving (8 oz. for beverages).

As used herein, the phrases “natural high-potency sweetener,” “NHPS,” “NHPS composition,” and “natural high-potency sweetener composition” are synonymous. “NHPS” means any sweetener found in nature which may be in raw, extracted, purified, treated enzymatically, or any other form, singularly or in combination thereof and characteristically has a sweetness potency greater than sucrose, fructose, or glucose, yet has fewer calories. Non-limiting examples of NHPS's suitable for embodiments of this invention include Rebaudioside A, Rebaudioside B, Rebaudioside C (dulcoside B), Rebaudioside D, Rebaudioside E, Rebaudioside F, dulcoside A, rubusoside, stevia, stevioside, mogroside IV, mogroside V, Luo Han Guo sweetener, siamenoside, monatin and its salts (monatin SS, RR, RS, SR), curculin, glycyrrhizic acid and its salts, thaumatin, monellin, mabinlin, brazzein, hernandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, and cyclocarioside I.

NHPS also includes modified NHPS's. Modified NHPS's include NHPS's which have been altered naturally. For example, a modified NHPS includes, but is not limited to, NHPS's which have been fermented, contacted with enzyme, or derivatized or substituted on the NHPS. In one embodiment, at least one modified NHPS may be used in combination with at least one NHPS. In another embodiment, at least one modified NHPS may be used without a NHPS. Thus, modified NHPS's may be substituted for a NHPS or may be used in combination with NHPS's for any of the embodiments described herein. For the sake of brevity, however, in the description of embodiments of this invention, a modified NHPS is not expressly described as an alternative to an unmodified NHPS, but it should be understood that modified NHPS's can be substituted for NHPS's in any embodiment disclosed herein.

As used herein, the phrase “artificial sweetener” or “synthetic sweetener” refers to any composition that is not found in nature and is a high potency sweetener. Non-limiting examples of artificial or synthetic sweeteners suitable for embodiments of this invention include sucralose, acesulfame potassium (acesulfame K or aceK) or other salts, aspartame, alitame, saccharin, neohesperidin dihydrochalcone, cyclamate, neotame, N-[3-(3-hydroxy-4-methoxyphenyl)propyl]-L-α-aspartyl]-L-phenylalanine 1-methyl ester, N-[3-(3-hydroxy-4-methoxyphenyl)-3-methylbutyl]-L-α-aspartyl]-L-phenylalanine 1-methyl ester, N-[3-(3-methoxy-4-hydroxyphenyl)propyl]-L-α-aspartyl]-L-phenylalanine 1-methyl ester, and salts thereof.

One aspect of the present invention is directed to using a blend of non-nutritive sweeteners. The blend of non-nutritive sweeteners lends qualitative synergy to the taste of a low-calorie beverage in which it is included. Any blend of non-nutritive sweeteners can be employed in the present invention including two-, three-, four- and five-way blends of non-nutritive sweeteners.

One of ordinary skill in this art will readily appreciate that non-nutritive sweeteners may be combined in various ratios to form a non-nutritive sweetener blend suitable for use in the present invention. Precise ratios of non-nutritive sweeteners depend on the combination of sweeteners used in a given blend and the desired overall sweetness for a given application. Appropriate ratios can be readily determined by one of ordinary skill in this art.

One of ordinary skill in this art will also readily appreciate that the amount of the blend of non-nutritive sweeteners in a finished beverage will vary depending on a variety of factors such as the desired overall sweetness for a given application. Appropriate amounts can be readily determined by one of ordinary skill in this art.

In addition to the non-nutritive sweetener or sweetener blend, erythritol is included in a diet beverage in order to improve the overall taste. The erythritol (i.e. meso-erythritol) is included in an amount from 0.1% to 3.5% by weight based on finished beverage weight, preferably from 0.2% to 2.5% by weight based on finished beverage weight, and more preferably from 0.3% to 1.5% by weight based on finished beverage weight.

In addition to the erythritol, other sugar alcohols may be used to block the lingering sweetness and the bitter/metallic aftertaste associated with the use of non-nutritive sweeteners. Sugar alcohols suitable for use in the present invention in addition to the erythritol include, without limitation, sorbitol, mannitol, lactitol, maltitol, xylitol, and combinations thereof.

D-tagatose is also included in the diet beverage in order to improve the overall taste. The use of D-tagatose enhances mouthfeel (also referred to as body, thickness or delocalization of sweetness). D-tagatose is included in an amount from 0.1% to 1.0% by weight based on finished beverage weight, preferably 0.12% % to 0.9% by weight based on finished beverage weight, and more preferably 0.2% to 0.6% by weight based on finished beverage weight.

The bulking agent maltodextrin is added to the frozen beverages to improve overall texture and mouthfeel. It provides a bland neutral flavor while contributing to viscosity and body. Maltodextrin functions as a bulking agent, texturizer, carrier, and crystallization inhibitor. Maltodextrin is included in an amount from 0.05% to 1% by weight based on finished beverage weight, preferably 0.07 to 0.75% by weight based on finished beverage weight, and more preferably 0.1% to 0.5% by weight based on finished beverage weight.

Gums such as cellulose gum or xanthan gum may also be added to the frozen beverages. Such gums function as a bulking agent. The addition of the bulking agents to low calorie syrups (low solids) provide additional solids that will help lower the freezing point of the syrup as well as provide “bulk” to give the product more desirable texture and mouthfeel.

The nutritive sweetener may be high fructose corn syrup. Such nutritive sweeteners add flavor, bulk, sweetness, and freezing qualities. Nutritive sweeteners are included in an amount from 1% to 7.5% by weight based on finished beverage weight, preferably 1.5% to 7% by weight based on finished beverage weight, and more preferably 2% to 6% by weight based on finished beverage weight. The current landscape of full calorie (120-150 calories per 8 oz serving) frozen beverages contain sweetener levels ranging from 15-20% of the finished beverage by weight. This invention represents at least a 50% reduction in sugar in the finished beverage by weight.

Thus, the present invention is further directed to low-calorie frozen beverages which include (a) at least one non-nutritive sweetener, (b) erythritol, (c) D-tagatose, (d) maltodextrin as a bulking agent, (e) a nutritive sweetener, and optionally (f) a gum.

It is possible to include any other ingredients typically used in diet frozen beverages in appropriate amounts. Such other ingredients include, without limitation, acidulants, flavors, soluble low-calorie fibers such as polydextrose, Fibersol, arabinogalactan, chitosan, chitin, xanthan, pectin, konjac, gum arabic, modified starch, soy fiber, inulin, inulose, hydrolyzed guar, beta-glucan, carageenan, locust bean gum, alginate, polyglycol alginate, foam stabilizing agents such as yucca or yucca/quillaia extracts, salts such as sodium, calcium and potassium chlorides, food grade surfactants such as monoglycerides, diglycerides, lecithin and fractions thereof, and synthetic surfactants such as Tweens®, Spans®, diacetyltartaric esters, citric acid esters, etc.

Preservatives such as sodium benzoate or potassium sorbate may also be included in the beverages.

In addition to beverages, the present invention is directed to syrups used to make the beverages. The amounts provided above correspond to the beverage. To achieve the amounts, the syrup is diluted with one part of finished syrup to 3 to 7 parts of water, typically 5 parts water. The present invention is also directed to a method of improving the texture and mouthfeel of low-calorie frozen beverages. The method (1) combines (a) at least one non-nutritive sweetener, (b) erythritol, (c) D-tagatose, (d) maltodextrin in an amount effective as a bulking agent and (e) a nutritive sweetener; (2) loads the reduced-calorie frozen beverage syrup into a dispensing machine; and (3) dispenses the reduced-calorie frozen beverage. Carbonation may be added as is within the skill of the art.

The examples which follow are intended as an illustration of certain preferred embodiments of the invention, and no limitation of the invention is implied.

### Example 1

### Low Calorie Beverages (Beverages Containing 0-40 Calories Per 8 Oz Serving)

A finished beverage is prepared by first combining the following ingredients to provide a finished syrup. The finished syrup is then diluted at one part of finished syrup with five parts of treated water and mixing.

| | 1 | 2 | 3 | 4 | 5 | 6 | 7 |
|---|---|---|---|---|---|---|---|
| Sodium Benzoate | 2.88 | 2.88 | 2.88 | 2.88 | 2.88 | 2.88 | 2.88 |
| Citric Acid Anhydrous | 3.98 | 3.98 | 3.98 | 3.98 | 3.98 | 3.98 | 3.98 |
| Erythritol | 122.48 | 122.48 | 122.48 | 122.48 | 428.74 | 428.74 | 122.48 |
| D-Tagatose | 30.63 | 30.63 | 30.63 | 30.63 | — | — | 30.63 |
| Acesulfame K | 0.18 | 0.18 | — | — | — | — | — |
| Sucralose | 0.46 | 0.46 | — | — | — | — | — |
| Maltodextrin | — | 13.6 | — | 13.6 | — | — | — |
| Rebaudiside A | — | — | 0.60 | 0.60 | 0.60 | — | — |
| HFCS | 746.32 | 566.47 | 745.93 | 566.08 | 387.95 | 388.76 | 746.71 |
| Treated Water | 1366.52 | 1486.14 | 1366.94 | 1486.57 | 1489.29 | 1449.08 | 1366.77 |

The mixture is then poured into a hopper of a frozen beverage unit. The resulting product is frozen, dispensed, and can be combined with a variety of flavored syrups. Frozen beverage units include but are not limited to Taylor 428, Taylor 430, Bunn Ultra I and Bunn Ultra II.

The products that did not contain maltodextrin were not as structurally stable as those that did. Products without maltodextrin melted faster and the frozen matter separated at a faster rate than products that contained maltodextrin. Further, products without maltodextrin were not as thick as products with maltodextrin. Products with maltodextrin included better binding and thickening of the product, and functioned closer to their full calorie counterparts, not only providing a similar body and texture, but also optimal “structure maintenance.” The addition of maltodextrin also helped mask the off flavor perceived from the addition of the high intensity sweeteners.

### Example 2

### Reduced Calorie Beverages (Beverages Containing 0-80 Calories Per 8 Oz Serving)

A finished flavored beverage is prepared by first combining the following ingredients to provide a finished syrup. The finished syrup is then diluted at one part of finished syrup with five parts of treated water and mixing.

| Ingredient | 1 | 2 | 3 | 4 |
|---|---|---|---|---|
| Sodium Benzoate | 2.16 | 2.16 | 2.16 | 2.16 |
| Citric Acid Anhydrous | 13.54 | 13.54 | 13.54 | 13.54 |
| Erythritol | 45.93 | 91.86 | 91.86 | 45.93 |
| D-Tagatose | 11.49 | 22.97 | 22.97 | 11.49 |
| Acesulfame K | 0.77 | 0.77 | 0.77 | 0.77 |
| Sucralose | 2.45 | 2.45 | 2.45 | 2.45 |
| Maltodextrin | — | 10.20 | 10.20 | 13.6 |
| Flavor | 9.10 | 9.10 | 9.10 | 9.1 |
| Flavor Modifier | — | — | 2.40 | 2.40 |
| Flavor Masker | — | — | 0.87 | 0.87 |
| Color | 6.78 | 6.78 | 6.78 | 6.78 |
| HFCS | 806.032 | 718.22 | 714.97 | 802.78 |
| Treated Water | 859.56 | 879.76 | 879.742 | 859.547 |

The mixture is then poured into a hopper of a frozen beverage unit. The resulting product is frozen, dispensed, and can be combined with a variety of flavored syrups. Frozen beverage units include but are not limited to Taylor 428, Taylor 430, Bunn Ultra I and Bunn Ultra II.

Variants were prepared in accordance with the above process and tested using a Monadic CLT quantitative design with a total population size of n=1000. Variants included 3 reduced sugar variants and 1 full calorie variant in Cherry and Blue Raspberry flavors (8 total). Respondents consumed a full serve product of 16 fl oz serving size.

Screening criteria included past month slushy beverage users (must have consumed at least 1 slush beverage within the month), Top 2 Box Concept (when presented with the test screener, respondent must have indicated that they “would” or “probably would”—for example—buy such a beverage) and Flavor acceptors (when presented with the test screener, responded must have indicated that they are “accepting” of the flavor been tested—in this case—cherry and raspberry), 50% male/50% female, ranging from ages 16-45 years.

All variants tested met or exceeded the Action Standard in comparison to full calorie benchmarks.

Variants that contained maltodextrin exceeded the Action Standard based upon all key performance indicator metrics and ranked higher in Top 2 Box PI and Overall Liking Mean, Comparison to Expectations, Comparison to Other Slushy Beverages, and Uniqueness.

Aftertaste Perception was on par with the benchmark. Those who did perceive aftertaste skew positively, negative aftertaste was negligible. Product tasted “like a regular/non-diet beverage”—more than the benchmark.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A reduced-calorie frozen beverage comprising: (a) at least one non-nutritive sweetener, (b) erythritol, (c) D-tagatose, (d) maltodextrin, and (e) a nutritive sweetener.

2. The reduced-calorie frozen beverage according to claim 1 wherein the erythritol is present in an amount of 0.1% to 3.5% by weight based on finished beverage weight.

3. The reduced-calorie frozen beverage according to claim 1 wherein the D-tagatose is present in an amount from 0.1% to 1.0% by weight based on finished beverage weight

4. The reduced-calorie frozen beverage according to claim 1, wherein the maltodextrin is present in an amount of from 0.01% to 1% by weight based on finished beverage weight.

5. The reduced-calorie frozen beverage according to claim 1, wherein the nutritive sweeteners are present in an amount from 1% to 7.5% by weight based on finished beverage weight.

6. The reduced-calorie frozen beverage according to claim 1, wherein the at least one non-nutritive sweetener includes at least one natural sweetener.

7. The reduced-calorie frozen beverage according to claim 6, wherein the at least one natural sweetener is selected from the group consisting of rebaudioside A, rebaudioside B, rebaudioside C, rebaudioside D, rebaudioside E, rebaudioside F, dulcoside A, rubusoside, stevia, stevioside, mogroside IV, mogroside V, Luo Han Guo sweetener, siamenoside, monatin and its salts, curculin, glycyrrhizic acid and its salts, thaumatin, monellin, mabinlin, brazzein, hernandulcin, phyllodulcin, glycyphyllin, phloridzin, trilobtain, baiyunoside, osladin, polypodoside A, pterocaryoside A, pterocaryoside B, mukurozioside, phlomisoside I, periandrin I, abrusoside A, and cyclocarioside I.

8. The reduced-calorie frozen beverage according to claim 6, wherein the at least one natural sweetener is selected rebaudioside A.

9. The reduced-calorie frozen beverage according to claim 1, wherein the at least one non-nutritive sweetener includes at least one artificial sweetener.

10. The reduced-calorie frozen beverage according to claim 9, wherein the at least one artificial sweetener is selected from the group consisting of sucralose, acesulfame potassium or salts thereof, aspartame, alitame, saccharin, neohesperidin dihydrochalcone, cyclamate, neotame, N-[3-(3-hydroxy-4-methoxyphenyl)propyl]-L-α-aspartyl]-L-phenylalanine 1-methyl ester, N-[3-(3-hydroxy-4-methoxyphenyl)-3-methylbutyl]-L-α-aspartyl]-L-phenylalanine 1-methyl ester, N-[3-(3-methoxy-4-hydroxyphenyl)propyl]-L-α-aspartyl]-L-phenylalanine 1-methyl ester, and salts thereof.

11. The reduced-calorie frozen beverage according to claim 9, wherein the at least one artificial sweetener is sucralose or acesulfame potassium.

12. The reduced-calorie frozen beverage according to claim 1, wherein the at least one non-nutritive sweetener includes a mixture of at least one natural sweetener and at least one artificial sweetener.

13. The reduced-calorie frozen beverage according to claim 1, wherein the nutritive sweetener is high fructose corn syrup.

14. The reduced-calorie frozen beverage according to claim 1 further comprising at least one gum.

15. The reduced-calorie frozen beverage according to claim 14 wherein the gum is cellulose gum or xanthan gum.

16. The reduced-calorie frozen beverage according to claim 1 comprising: (a) at least one non-nutritive sweetener; (b) 0.1% to 3.5% by weight erythritol based on finished beverage weight, (c) 0.1% to 1.0% by weight D-tagatose based on the finished beverage weight; (d) 0.05% to 1% by weight maltodextrin based on the finished beverage weight; and (e) 1% to 7% by weight nutritive sweetener based on the finished beverage weight.

17. A syrup for preparing a reduced-calorie frozen beverage comprising: (a) at least one non-nutritive sweetener, (b) erythritol, (c) D-tagatose, (d) maltodextrin, and (e) a nutritive sweetener.

18. The syrup according to claim 1 in amounts such that when water is added, a beverage is formed comprising (a) at least one non-nutritive sweetener; (b) 0.1% to 3.5% by weight erythritol based on finished beverage weight, (c) 0.1% to 1.0% by weight D-tagatose based on the finished beverage weight; (d) 0.05% to 1% by weight maltodextrin based on the finished beverage weight; and (e) 1% to 7% by weight nutritive sweetener based on the finished beverage weight.

19. A method of making a reduced-calorie frozen beverage comprising the steps of: (1) combining (a) at least one non-nutritive sweetener, (b) erythritol, (c) D-tagatose, (d) maltodextrin in an amount effective as a bulking agent and (e) a nutritive sweetener; (2) loading the reduced-calorie frozen beverage syrup into a dispensing machine; and (3) dispensing the reduced-calorie frozen beverage.

20. The method according to claim 19 wherein the reduced-calorie frozen beverage is uncarbonated.

21. The method according to claim 19 wherein the reduced-calorie frozen beverage is carbonated.

22. The method according to claim 18 comprising: (a) at least one non-nutritive sweetener; (b) 0.1% to 3.5% by weight erythritol based on finished beverage weight, (c) 0.1% to 1.0% by weight D-tagatose based on the finished beverage weight; (d) 0.05% to 1% by weight maltodextrin based on the finished beverage weight; and (e) 1% to 7% by weight nutritive sweetener based on the finished beverage weight.
